(19) United States
(12) Patent Application Publication
(10) Pub. No.: US 2018/0287976 A1
(43) Pub. Date: Oct. 4, 2018

(54) SYSTEM AND PROCESS FOR MONITORED VIDEO MESSAGING

(71) Applicant: Coby Hochstein, Mesa, AZ (US)

(72) Inventor: Coby Hochstein, Mesa, AZ (US)

(21) Appl. No.: 15/476,796

(22) Filed: Mar. 31, 2017

(51) Int. Cl. H04L 12/58; H04L 29/08; H04L 29/06; G06Q 20/18; G06Q 20/40; G06K 9/00

(52) U.S. Cl. CPC H04L 51/10; H04L 51/12; H04L 67/10; G06K 9/00718; H04L 63/0428; G06Q 20/18; G06Q 20/401; H04L 51/24

(57) ABSTRACT

Described is a system and process for monitored video communication wherein detainees, such as inmates in jail or prison, can receive recorded video messages from outside persons, such as family members, friends, and attorneys. The system processes a recorded video message from a customer approved to communicate with a detainee-recipient by executing certain computer-implemented verification, screening, and filtering processes followed by performance of intermediate review, final review, and approval for viewing by a natural person reviewer, such as a correctional officer of senior administrative staff member. Computer-executed processes speed review and approval of the recorded video message by screening the video using facial recognition, voice recognition, nudity recognition, maturity recognition, and similar stored indicia to prevent viewing of restricted and possibly objectionable content by the recipient.

### BACKGROUND OF THE INVENTION

### Technical Field

This invention relates to video messaging; and, specifically, to a system and process for monitored video communication in a controlled environment, such as a jail or prison.

### State of the Art

Currently available options for communication with persons detained in a governmental facility are limited. Prisoners in a jail or prison may make voice telephone calls under controlled conditions to family members and friends. This telephone communication is easier and may generally be conducted with greater frequency than an in-person visit. Such telephone voice-only communication, however, is limited and not as intimate as a face-to-face interaction with a detainee.

Other modes of communications, such as video messaging, can be at least as convenient as making a telephone call. However, because of a need for heightened security and the potential for abuse, video messaging is currently not widely available within most jails, prisons, and similar correctional facilities. Problems and limitations with the current state-of-the-art systems for video communication with a detainee are many, and include the lack of suitable means for directors of a correctional facility to efficiently and simultaneously screen and filter communications from a plurality of persons for illegal or lewd content, inability to separate and archive specific moments/incidents of heightened concern for later retrieval, recognition and confirmation of identity of person(s) appearing on the video, and means to create of a human readable summary.

Additionally, means for effective situational filtering of video content are lacking. For example, it is desirable to filter content to be viewed by a detainee using parameters pre-set by administrative staff of the correctional facility, such as maturity level (i.e., children) of subjects on the video, nudity, violent acts or messages including gang/terrorism or other conspirator-related messages, presence of guns or other weapons, and the like.

Accordingly, what is needed is a process, including a system, apparatus, and methods of implementation, for efficiently providing filtered video communications, including recorded or real-time messages, between a person-customer and a second person-inmate detained in a correctional or related-type secured facility, or in a similar restricted situation.

### SUMMARY OF EMBODIMENTS

Disclosed is a system for monitored video messaging comprising a cloud server; a remote computing device communicatively coupled to the cloud server comprising a messaging application, wherein a customer uploads a video formatted by the messaging application to the cloud server from the remote computing device; a facility server communicatively coupled to the cloud server and comprising a filtering application, wherein the filtering application screens the video message against an indicium to create a filtered video message; and a viewing station, wherein a recipient views the filtered video message at the viewing station.

In some embodiments, the recipient is an inmate of a correctional facility. In some embodiments, the facility server is remotely located separate from a correctional facility.

In some embodiments, the indicium is a facial-recognition indicium. In some embodiments, the indicium is a voice-recognition indicium. In some embodiments, the indicium is a nudity-recognition indicium. In some embodiments, the indicium is a maturity-recognition indicium. In some embodiments, the indicium is a weapon-recognition indicium.

In some embodiments, the cloud server comprises an encryption utility.

In some embodiments wherein the customer is an attorney, the messaging application comprises an encryption utility; the encryption utility encrypts the video message; and the remote computing device uploads the encrypted video message to the cloud server.

Disclosed is a system for monitored video messaging comprising a facility server having a filtering utility; a databank populated with indicia; and a video message; wherein the filtering utility compares the video message with the indicia to create a filtered video message; and a viewing kiosk communicatively coupled to the facility server, having a recipient verification utility that verifies a recipient identity; a payment utility that verifies a payment; and a monitor, wherein the filtered video message is viewed at the viewing station by the recipient following verification of the recipient identity and the payment.

In some embodiments, the payment is provided by the recipient at the kiosk. In some embodiments, the payment is provided by a third party.

In some embodiments, the facility server is communicatively coupled to a cloud server, wherein the video message is received by the facility server from the cloud server. In some embodiments, the facility servicer is communicatively coupled to a remote computing device, wherein the video message is received by the facility server from the remote computing device.

Disclosed is a method for monitored video messaging comprising receiving a video message from a customer; validating the video message; processing the video message by comparing the video message to an indicium; approving the video message for viewing by a recipient; and viewing the video message by the recipient.

In some embodiments, the processing step comprises comparing the video message to an indicium; and selecting a filtered video message comprising the indicium.

In some embodiments, the method further comprises tendering a payment. In some embodiments, the method further comprises reviewing the video for final approval to be viewed by the recipient. In some embodiments, the method further comprises publishing an alert, wherein the alert notifies the recipient that the video is available for viewing.

### BRIEF DESCRIPTION OF THE DRAWINGS

FIG. 1 is a simplified diagram representing a system for monitored video messaging;

FIG. 2 is an additional simplified diagram representing a system for monitored video messaging;

FIG. 3 is a diagram representing the interplay between certain components of a system for monitored video messaging;

FIG. 4 is a stylized diagram of the interplay between components of a system for monitored video messaging;

FIG. 5 is a simplified diagram of a filtering utility for a system for monitored video messaging;

FIG. 6 is a flowchart diagram of a system for monitored video messaging;

FIG. 7 is a block diagram of a method of monitored video messaging; and

FIG. 8 is a block diagram of an additional method of monitored video messaging.

### DETAILED DESCRIPTION OF EMBODIMENTS OF THE INVENTION

Communication is limited between detainees, such as inmates, residing in prisons, jails, or similar correctional facilities and their families and friends outside of the facility. Because living conditions in a correctional facility are necessarily restrictive, inmates are motivated to seek pleasures and amenities more easily available to persons in society at large. Additionally, communication between inmates and non-incarcerated persons may relate to facilitating criminal activity undertaken outside the confines of the inmate's prison or jail. Providing an inmate access to communication with an individual outside of the detainee's correctional facility, therefore, creates a security risk.

Current video processing technology is generally limited to manually-executed processes with limited means for automated computer-executed video filtering. For example, a person tasked with monitoring the content of a recorded video message can view the video while noting whether the language contains terms or phrases related to inciting violence or other criminal activity, whether the visual content contains nudity or inappropriate depictions of children or older minors, or whether a person appearing on the video is a known criminal, gang member, drug dealer, or the like. Moreover, currently available software for automated video screening and filtering is limited to recognition of only one indicium, such as either voice or face recognition, but not both simultaneously. There are additional problems and limitations with both manual review by a natural person and automated, computer-executed video processing.

For example, the ability of a natural person to screen and filter a video message is limited by the time it takes to watch the video. The ability for one to record every instance of concern, whether subjectively or by applying pre-determined objective criteria, is limited by an element of human error which cannot be completely eliminated. This and other human limitations are greatly amplified when a person attempts to view more than one recorded video at a time. Additionally, the ability for a person to successfully recognize and identify individuals in the video may be limited to the reviewer's direct involvement with or personal knowledge of a person of interest in the video.

Regarding current limitations of computer-executed screening and filtering of recorded video messages, existing software and systems lack the ability to create an overall historical human-readable summary of the video. Current software also lacks the ability to identify a “filter situation”—overall context signaling a need for heightened scrutiny—and subsequently determine how to proceed with filtering the remainder of the video. For example, if a person in the video (“subject”) is not the intended sender/message, if nudity, weapons, drugs, gang-sign, or other restricted visual elements are present, should a different filtering system be implemented, should the same filtering protocol be continued, or should processing of the recorded video be simply terminated? If children, multiple people, or no face is detected, how should the video continue to be filtered? Current systems and software also lack the functional ability to automatically send an automated text-message or email/online alert if the video contains content which violates a pre-set indicium or condition.

Embodiments of the instant invention provide solutions to these and other problems with the prior art. Embodiments of the invention comprise a filtering utility which is able to filter a recorded video automatically by simultaneously processing visual and aural elements of the video for voice, word, face, and visual context recognition wherein processing time is substantially reduced and errors are almost eliminated. The utility is able to detect and log the exact time-point on the recorded video wherein a restricted event occurs, and create a human-readable summary record of events, ordered chronologically. The utility is able to simultaneously process two or more recorded videos, limited only by the processing power of the processor. Moreover, the utility identifies and captures a face image from multiple perspectives of each sender, recipient, and subject(s) of a recorded video and archives these images in a digital library. The utility additionally integrates data filtered from the recorded video, including language, any nudity, visual context (scene), and user recognition indicia to create a comprehensive summary of the recorded video. A visual summary may also be created using charts, such as a linear timeline with each occurrence of a filtered event marked with a tag and/or a descriptive label, in sequence and at relative intervals through the time course of the recorded video.

Software comprised by the system not only automatically detects and logs situations of concern, it then decides how to proceed. For example, if a child is detected, the system records the event and continues filtering the video, if a permission command allowing viewing of children in the recorded video is sent to the filtering utility by a system administrator. If a group of persons, such as a wife and her children are subject on the video, the system can determine whether the recipient if married, has children, and whether the overall content and visual context is beneficial to the recipient. The system additionally determines whether the recorded video contains objectionable material, such as that comprising illegal content or tending to promote criminal activity. Child pornography is an example of illegal content. Brandishing of a weapon, such as a firearm, for example, along with related contextual visual elements may indicate gang-related activity or a motive to incite violence. Wherein the system detects such content, the system marks the video as illegal, violent, or gang-related and transmits an automated alert to administrative or monitoring staff regarding the possible harmful, exploitive, or other illegal situation. The aforementioned scenarios are offered only by way of example, and are not meant to be limiting.

Described herein above is a system and process for providing monitored video communication. Embodiments of the invention provide a process and system for video messaging which can be utilized by correctional facilities to provide video message exchange between inmates and approved non-incarcerated persons, such as family members and others. In summary, a non-incarcerated customer may create a video message using an available conventional means. The customer then imports the video message to a messaging application residing on a remote computing device. The messaging application communicates with a remote server, such as a cloud-based server, via a network connection, such as an Internet connection, through a standard available protocol and means. The server comprises a memory and a processor on which resides a utility application which receives, logs, and screens the video. After screening, the video is filtered by a filtering utility residing on the processor against multiple indicia, such as language, attitude, presence of nudity, contextual visual elements related to the scene, and user/actor recognition. These indicia are stored in a second memory, accessed by the filtering utility which compares corresponding indicia on the video message with the stored indicia to determine whether the video message contains restricted content or is sent from a restricted person or source. The remote cloud-based server then makes the screened and filtered video available for download by a facility server. A correctional officer or administrative staff member, either at the correctional facility or at a remote, centralized location, performs a brief final review prior to approving the video message for display to the inmate recipient. Once the video receives final approval, the system alerts the inmate recipient that the video message is available for viewing. The inmate-recipient may then choose whether to view the video at a monitor, kiosk, or similar viewing station available within the correctional facility.

Embodiments of the invention utilize a related but different process to screen and filter video messages from the inmates for delivery to a customer-recipient. The invention includes means for payment of fees associated with delivering screened and filtered video messages between inmates and customers, which may be paid by either the inmate or the customer, depending on the particular described embodiment.

A ‘utility’ as used herein refers to any device or software that creates an output, performs a task on an input, or performs a computation, in response to receiving an input. A utility can be software code, an electronic circuit, a combination of hardware and software, a programmable device, application specific hardware, or any other implementation of hardware circuits or software that accomplishes a task or computation. “Screen” means to examine or separate into different groups based upon content. Screening may be performed by a natural person, may be a computer-executed process, or may be a combination of human and computer-executed processes. “Filter” means software for blocking access to certain material. Like screening, filtering of video material may be performed by a natural person, be computer executed, or comprise a combination of human and computer-executed processes.

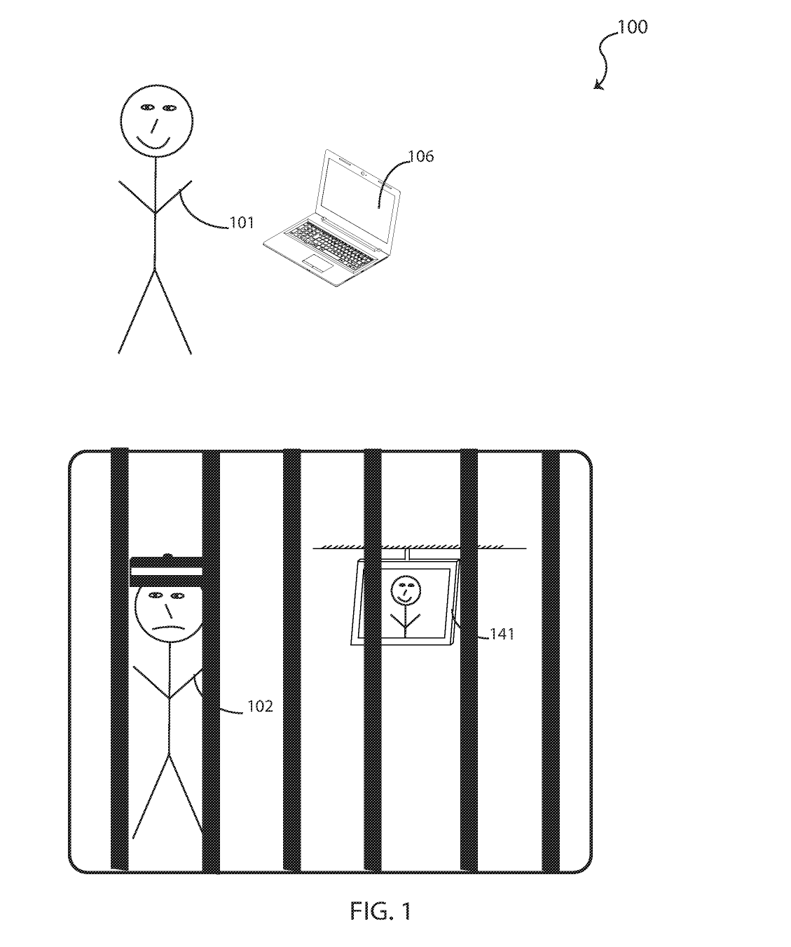

FIG. 1 is a simplified diagram representing a system for monitored video messaging. As shown in FIG. 1, a system and process for monitored video communication 100 provides for a customer 101 to create a video message using an available conventional video recording means. Once the video is created, customer 101 uploads the video using a remote computing device (“RCD”) 106. RCD 106 transmits the video for eventual viewing by a recipient 102 on a suitable viewing device, such as a viewing station 141 as shown in FIG. 1. System 100 comprises many additional elements, which are discussed in detail herein below, to allow extensive processing and filtering of the video created by customer 101. These additional elements allow an administrator of system 100 to exert considerable control on the video's content. A natural person need not view the entire video prior to approving and allowing the video to be viewed by recipient 102. System 100 additionally comprises a means and process for recipient 102, should they wish to respond, for creating a second video for delivery from recipient 102 to customer 101.

Customer 101 and recipient 102 are any two natural persons located in physically separate locations. Because of the highly detailed screening and filtering functions comprised by system 100, recipient 102 may be a detainee or inmate in an institutional facility 111, such as a jail, a prison, or a similar detention facility wherein recipient 102 is not necessarily able to communicate freely or privately with customer 101. Accordingly, customer 101 is typically a friend or family member of the detainee. Alternatively, customer 101 may be a counselor, teacher, clergy member, social worker, legal aid worker, or the like.

As used herein, “recipient,” detainee,” and “inmate” are used interchangeably and mean a person who is not free to communicate with others in a private, unsupervised, unmonitored, uncensored, or otherwise unrestricted manner. Similarly, the terms “facility,” “correctional facility,” “jail,” and “prison” are also used interchangeably and mean a physical location wherein persons, such as recipient 102, are detained under conditions under which personal liberties, including interpersonal interactions and communication, are restricted.

In the embodiment of system 100 shown in FIG. 1, RCD 106 is a laptop computer. This is by illustration only and not meant to be limiting. RCD 106 may be any computing device, including but not necessarily limited to a desktop computer, a laptop computer, a smartphone, a smartwatch, and the like. RCD 106 comprises an RCD memory, an RCD processor, and an RCD communication link wherein RCD 106 may upload and download electronic data files, such as video files, for example. In some embodiments, a messaging application 107 is resident on RCD processor, wherein customer 101 may create a first video message 108. The communication link may comprise a wireless communication link, such as WiFi, telecommunications network link, Bluetooth, or the like. Alternatively, the communication link may comprise a “wired” link, such as and Ethernet, a fiber optic link, or the like.

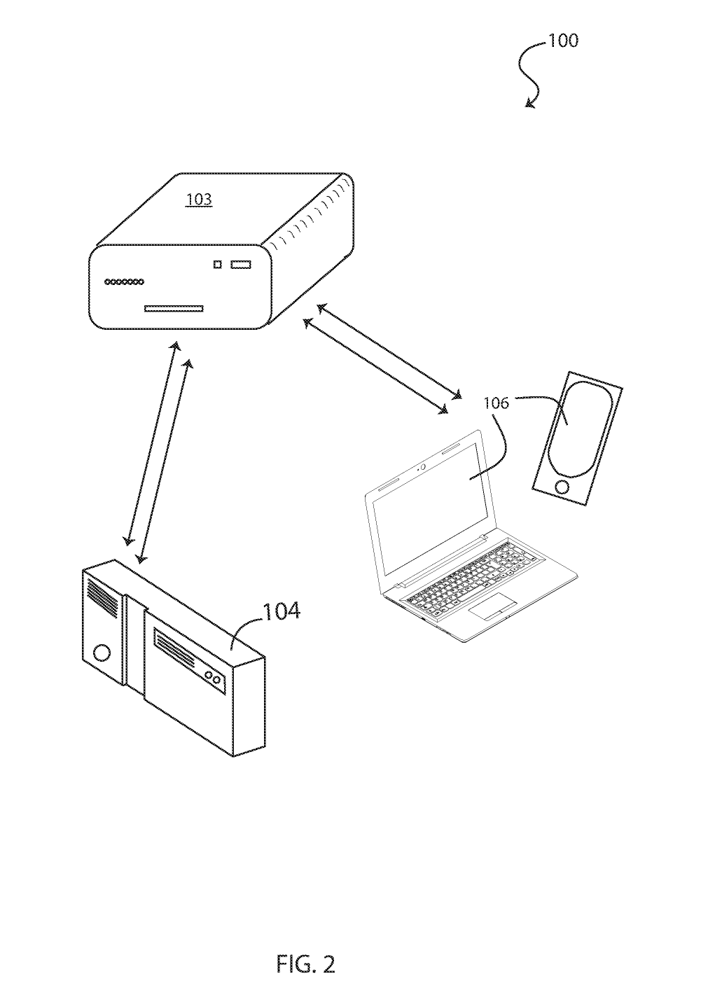

FIG. 2 is an additional simplified diagram representing a system for monitored video messaging. As shown by FIG. 2, in some embodiments of system 100, RCD 106 is communicatively coupled to a cloud server 103. Cloud server 103 is, in turn, communicatively coupled to a facility server 104.

Cloud server 103 is a computing device comprising a cloud memory, a cloud processor, and a cloud communications link. Cloud processor of cloud server 103 comprises a screening utility resident on the cloud processor wherein the first video message received from customer 101 via RCD 106 is screened against criteria chosen and set by an administrator of system 100, such as an administrator of a jail or prison. System 100, in response to application of these criteria by cloud server 103 to the video message provided by customer 101, 1) controls access of videos by certain individual customers 101 to individual recipients 102; and 2) controls content of the video message viewed by recipient 102 without direct “manual” screening by a natural person. These criteria, otherwise referred to as indicia, are discussed at length herein below.

Facility server 104 is a computing device comprising a facility memory, a facility processor, and a facility communications link. Facility processor performs various functions on the video which was initially screened and processed by cloud server 103, as discussed in detail herein below. In some embodiments of the invention, facility server 104 is physically located at the same location as recipient 104, including but not limited to a jail, a prison, or a similar institutional facility housing detainees. This is not meant to be limiting, however. Facility server 104 may be located in a centralized private administrative facility, or similar-type location physically remote from the recipient's location, housing staff which administer or oversee a plurality of detention facilities in geographically different locations, including locations in the same and/or different regions, states, or countries.

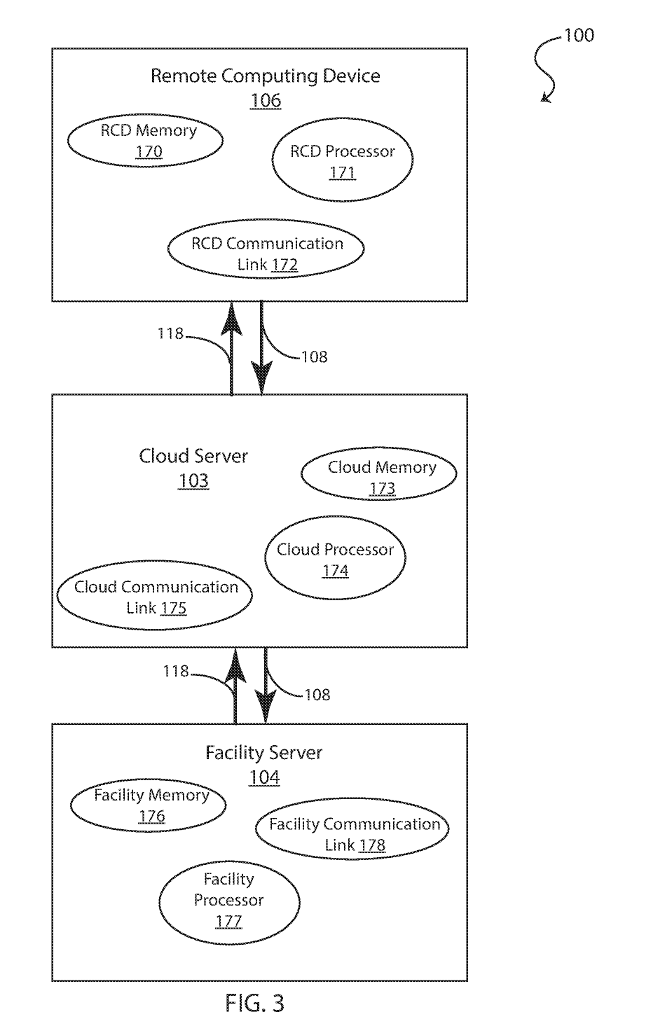

FIG. 3 is a diagram representing the interplay between certain components of a system for monitored video messaging. FIG. 3 shows the flow of first video message 108 and a second video message 118 through RCD 106, cloud server 103, and facility server 104. Delivery of first video message 108 is initiated by customer 101. Delivery of second video message 118 is initiated by recipient 102, regardless of whether second video message 118 is sent in response to viewing first video message 108 from customer 101. In some embodiments, therefore, recipient 101 initiates delivery of second video message 118 to customer 101 in the absence of first video message 108. In some embodiments, second video message 118 is sent by recipient 102 in response to viewing of first video message 108 from customer 101 by recipient 102. As shown by FIG. 3, RCD 106 comprises an RCD memory 170, an RCD processor 171, and an RCD communication link 172. RCT memory 170 stores data, such as first video 108, registration information collected from customer 101, and the like, in some embodiments. RCD processor performs computed-executed process of system 100 associated with creating, encoding, encrypting, and saving first video 108, in some embodiments, through messaging application 107 resident on RCD processor 171. RCD communication link 172 establishes electronic communication with cloud server 103 using a commercially available Internet connection or cellular network, in some embodiments, wherein first video 108 is uploaded from RCD 106 to cloud server 103. In some embodiments, RCD communication link 172 additionally enables RCD 106 to upload first video 108 created on other electronic devices or digital video recording devices for storage on RCD memory 170 for subsequent retrieval for viewing by customer 101 prior to initiating upload of saved first video 108 from RCD 106 to cloud server 103.

Cloud server 103 comprises a cloud memory 173, a cloud processor 174, and a cloud communication link 175. Cloud memory 173 stores first video 108 received from RCD 106. In some embodiments, cloud memory 173 stores second video 118 created by recipient 102 and received from facility server 104. Additional data is stored on cloud memory 173, in some embodiments, such as archived first videos 108 and second videos 118, registration information o customer 101, registration and background information of recipient 102, population indicia for use by screening utility 113 and filtering utility 120, criminal record and related databases, and the like. Cloud communication link 175 is a communications utility electronically coupled to a wired Internet connection, in some embodiments. Cloud communication link 175 facilitates uploading of first video 108 and second video 118. Cloud communication link 175 additionally facilitates downloading of first video 108 from cloud memory 173 to facility server 114 and downloading of second video 118 from cloud memory 173 to RCD 106.

Facility Server 104 comprises a facility memory 106, a facility processor 177, and a facility communication link 178. Facility memory 106, in some embodiments, stores recipient 102 registration and background data, customer 101 registration data, permission data allowing recipient 102 to receive first video message 108 from customer 101, and the like. Facility processor 177 interfaces with cloud server 103 and a local user, such as a correctional officer or facility administrative staff, to perform final computer-executed processing on first video 108 prior to final approval of first video 108 for viewing by recipient 102, with or without additional manual screening and filtering by a correctional officer or administrative staff member.

It should be noted that cloud server 103, in some embodiments, is communicatively coupled to a plurality of RCD 106 devices. Additionally, in some embodiments, a plurality of facility servers 104 are communicatively coupled to one cloud server 103. In this manner, a single cloud server 103 receives, logs, screens, filters, and archives recorded video messages 108 from any number of RCD 106 devices from any number of customers 101 in any number of geographic locations, according to the size of a particular embodiment of system 100. Moreover, one cloud server 103 may interface with any number of facility servers 104 at any number of institutional facilities 111 in any number of geographic locations, according to the size of a particular embodiment of system 100.

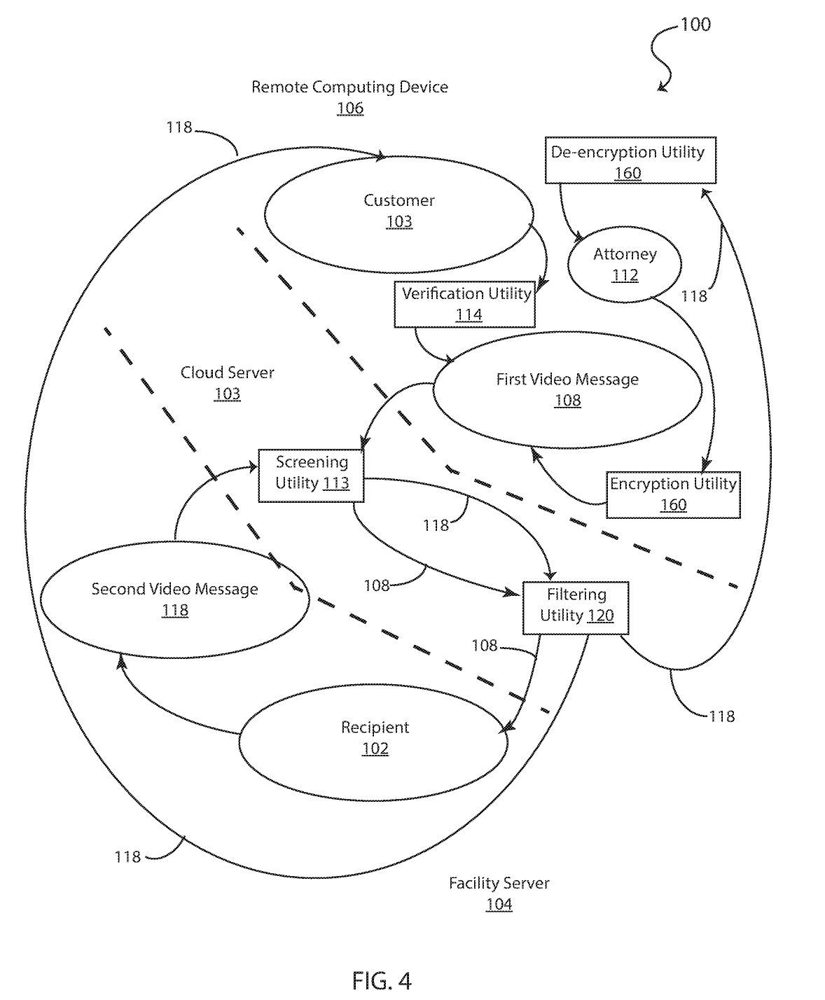

FIG. 4 is a stylized diagram of a system for monitored video messaging intended to provide a broad schematic overview of different processes comprised by system 100. System 100 comprises various processes executed by natural persons in concert with additional computer-executed processes. As represented by FIG. 4, the computer-executed processes of system 100 are performed, in some embodiments, by a network of three separate computing devices: remote computing device 106; cloud server 103; and facility server 104. As a first video message 108 created by customer 108 or a second video message 118 created by recipient 102 flow through system 100, first message 108 and second message 118 are subject to restriction from delivery and viewing by recipient 102 (first video message 108) or customer 101 (second video message 118) in response to the computer-executed processes performed by these three computing devices. Additional classification and restrictive processes may be performed by natural persons administering system 100.

As shown by FIG. 4, first video message 108 is provided by customer 101 via remote computing device 106. Customer 101 is most typically a family member of the inmate, although, customer 101 may alternatively be a counselor, educational provider, volunteer, social worker, or the like. In some embodiments, customer 101 creates first video 108 on remote computing device 106. In other embodiments, first video 108 is created, by customer 101 or a third party 151, on a separate video recording device and uploaded as a computer-readable video file in a standard format to remote computing device 106. The length of first video 108 is limited by the processing power of individual processor elements of cloud server 103 and facility server 104, however, first video 108 is typically within a range of about thirty (30) seconds to about five (5) minutes in length.

In some embodiments, the customer is an attorney 112, who may provide first video message 108 for viewing of recipient 102. Because of professional ethical requirements regarding confidentiality of the attorney-client relationship and attorney work product, RCD 106, in some embodiments, comprises an encryption utility 160 residing on the RCD processor. The encryption utility encrypts first message 108 to prevent a portion of or all content of the encrypted first message 108 from being viewed by any person other than recipient 102, including prison administrative, prosecutorial staff, law enforcement officials, and the like. In some embodiments, system 100 comprises a de-encryption utility 161 residing on cloud server 103 wherein the encrypted video message 108 is de-encrypted for retrieval when required under limited circumstances, such as upon receipt of a court-ordered subpoena, for example. Otherwise, video messages 108 provided by attorney 112 will not be filtered by the filtering utility nor will they be archived, in some embodiments. After viewing by recipient 102, first video message provided by attorney 112 may be destroyed within a predetermined time period, such as several hours to one or two days. In this manner, some embodiments of system 100 comprise a secure means wherein a detainee's attorney 112 may create and deliver confidential, privileged, video-based communications to recipient 102.

Customer 101 must establish an account and provide login information and an authentication means, such as a password, fingerprint, facial recognition image, or other identifying biometric data prior to uploading a video from RCD 106 to cloud server 103. In some embodiments of system 100, customer 101 may authorize additional individuals to login using one account, such as children or other family members of customer 101. Separate individualized authentication means are provided by each person authorized to use the login information of customer 101 for the same account. The login information and authentication means is input to a verification utility 114 resident on RCD 106. After confirming the existence of a valid, active account matching the login information provided by customer 101 or other authorized user, verification utility 114 confirms the identity of customer 101 or authorized user by matching the received authentication data to saved data. Following this identity verification, verification utility 114 allows customer 101 to upload first video 108 from RCD 106 to cloud server 103. Uploading of video 108 by verification utility 114 is similar to sending a video file using a conventional email, SMS, or MMS protocol.

As shown by FIG. 4, first video message 108 is transmitted by RCD 106 to facility server 104 via cloud server 103, in some embodiments. Cloud server 103 receives first video message 108, logs receipt, and queues first video message 108 for validation screening and filtering. A screening utility 113 residing on cloud processor 174 conducts computer-executed initial screening actions to verify that first video 108 is properly formatted, and is received from customer 101 who is properly registered and approved for to exchange or send recorded video messages with recipient 102. Corrupted, improperly formatted, or encrypted first video messages 108 are rejected for either archiving or removal from system 100 by screening utility 113. A video message 108 determined by validation screening to be from a non-approved person, whether attorney 112 or other customer 101, is also rejected. In some embodiments, these rejected messages are archived in cloud memory 173. In other embodiments, a rejected video message is transmitted by cloud server 103 for archiving in by facility server 104 in facility memory 176, or simply deleted from system 100.

First video messages 108 that are not rejected in response to the initial validation screening by cloud server 103 are retained and undergo further processing. In some embodiments, screening utility 113 resident on cloud server 103 processes first video 108 to confirm proper validation by verification utility 114 (not shown). This “double authentication” increases the security of system 100 by decreasing opportunities for “hacked” access to a customer's account to result in a video message from an unauthorized customer 101 to be viewed by recipient 102.

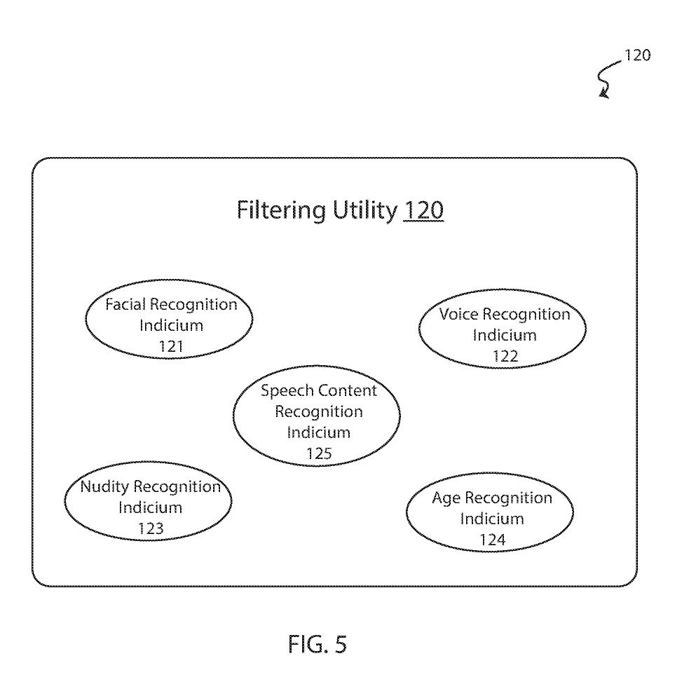

After initial screening, a filtering utility 120 compares the screened first video 108 to indicia. In some embodiments, filtering utility 120 comprises one or more of a group of indicia comprising a facial-recognition indicium 121, a nudity-recognition indicium 123, a voice-recognition indicium 122, an maturity recognition indicium 124, and a word or speech content recognition indicium 125. In some embodiments, filtering utility 120 utility has a flexible sampling rate and is compatible with commercially available hardware and operating system software. Details of filtering utility 120 are discussed herein below, in connection with FIG. 5.

Following screening and filtering within cloud server 103, video message 108 is downloaded to facility server 104. As discussed herein above, in some embodiments, facility server 104 is physically located at an institutional facility 111, such as a jail, prison, or other facility housing recipient 102. In some embodiments, facility server 104 is located in a geographically separate administrative facility, which may be located in another city, state, or country than institutional facility 111. Upon receipt onto facility server 104, additional screening is performed. For example, a natural person, whether an administrator or a correctional officer, may review whether recipient 102 has privileges to use system 100. If recipient 102 is allowed access to system 100, the reviewer may determine whether the person designated by customer 101 as recipient 102 is authorized to receive first video message 108 from that particular customer 101.

In some embodiments, a reviewer, such as an administrator or correctional officer, performs a manual review of first video 108, wherein the video reviewer examines a human-readable summary of first video 108 generated by filtering utility 120. The human readable summary comprises an indicator showing where, along a linear timeline of first video 108, the objectionable material, such as nudity, unauthorized subjects, or restricted words or phrases, if any, may be located. This expedites queueing up first video 108 for direct viewing of discrete episodes of objectionable content by a natural person reviewer.

Administrative personal of institutional facility 111 may configure additional parameters, such as maximum length, whether the subject may be a child or older minor, or the like. Following final approval, recipient 102 is notified that first video message 108 is available for viewing. The notification process is discussed further herein below. Once notified, recipient 102 may choose to view first video 108. After viewing, first video 108 may be archived on facility memory 176. In some embodiments, first video 108 is archived on cloud memory 173.

FIG. 5 is a simplified diagram of a filtering utility for a system for monitored video messaging. FIG. 5 shows filtering utility 120. Filtering utility 120 performs computer-executed processes on first video 108. In some embodiments, filtering utility 120 additionally performs computer-executed processes on second video 118. In some embodiments, these processes include identification and labeling, such as on a human-readable summary, of content comprised by first video 108 or second video 118 which may be illegal or otherwise objectionable, as determined by the administrator of system 100. In some embodiments, these processes additionally include blocking or deletion of such content from first video 108 or second video 118. “Screening” means identification of illegal or possibly objectionable content. “Filtering” means blocking or deletion of such content.

Illegal or possibly objectionable content is identified by comparing video and audio content with a plurality of indicia taken from audio or video data from a specific individual or a population of individuals which is recorded and saved on cloud memory 173. In some embodiments, filtering utility 120 utilizes facial recognition indicium 121 to identify and possibly block content comprises images of persons with whom recipient 102 is prohibited from contacting, such as known criminal associates of recipient 102, for example. In some embodiments, filtering utility 120 utilizes voice recognition indicium 122 to further identify and possibly block images or recorded audio from persons with whom recipient is prohibited from contacting. In some embodiments, filtering utility 102 utilizes nudity recognition indicium 123 to identify and possibly block recipient 102 from accessing pornographic or other restricted content. In some embodiments, filtering utility utilizes maturity recognition indicium 124 to identify and possibly block viewing of objectionable content associated with exploitation of minor children.

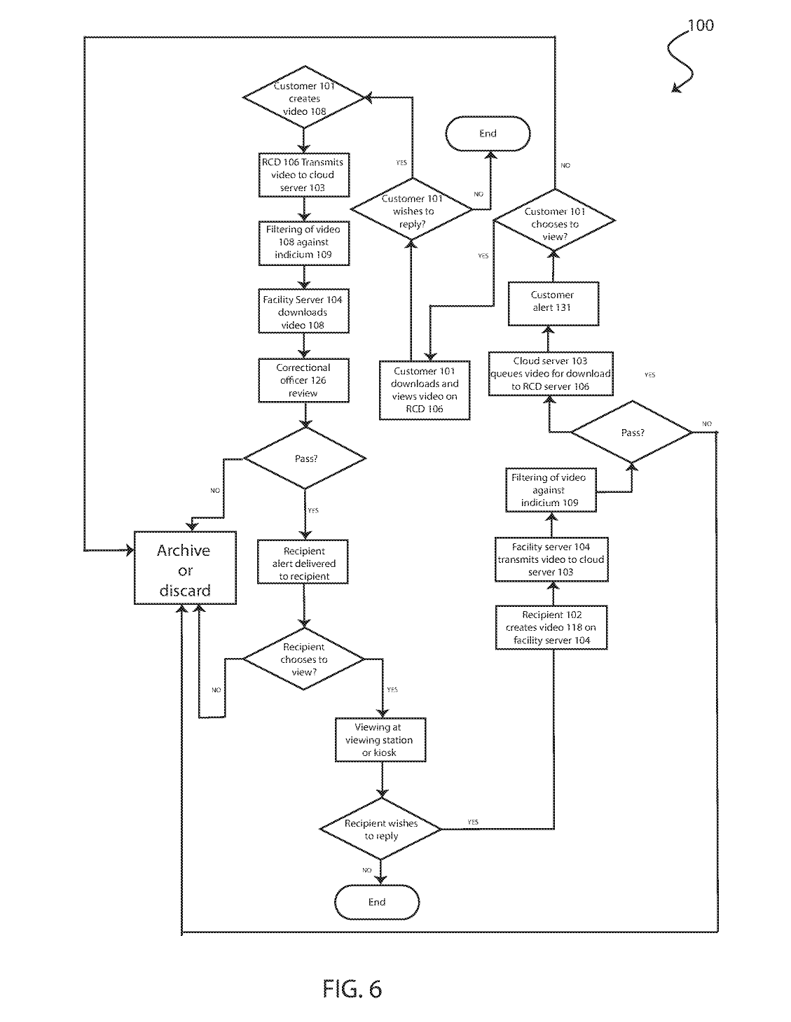

FIG. 6 is a flowchart diagram of a system for monitored video messaging. The linear path of a first video message 108 and a second video message 118 through system 100 is shown by FIG. 6. This flowchart diagram represents various features and processes of system 100, including both computer-executed processes and processes executed by natural persons. The processes illustrated by FIG. 6 are by way of example and not meant to be exclusive. Moreover, some embodiments of system 100 do not comprise each of the labeled and discussed processes. An example “walk-through” of system 100 is provided herein, with respect to FIG. 6.

As an initial step, in some embodiments, customer 101 creates video 108. Customer 101 must first an account, using messaging application 107 resident on RCD processor 171 of RCD 106, in some embodiments. In some embodiments, biometric data from customer 101 is collected, such as a face picture and a voice sample utilizing a camera and microphone comprised by RCD 106. The age and gender of customer 101 is recorded and verified by messaging application 107 by comparing the data inputted by customer 101 with database indicia resident on cloud memory 173. In some embodiments, customer 101 receives a computer-generated text message or email from cloud processor 174, to which customer 1012 must respond within a certain time limit for final verification. Additional verification and security measures may also be performed, in some embodiments. Following verification by cloud processor 174, customer 101 is allowed to login to messaging application 107. Customer 101 may add recipient 102 to customer's account. In some embodiments, cloud processor 174 prompts facility processor 177 to extend an invitation to recipient 101, who may automatically accept the invitation to send and receive video messages from customer 102. In some embodiments, initial approval for communication between customer 101 and recipient 102 myast also be provided by a corrections officer or administrative staff, who may or may not allow customer 102 and recipient 101 to exchange video messages, depending on a variety of circumstances. The correctional officer may require customer 102 to provide additional proof of identification, depending upon the circumstances, such as the relationship between customer 102 and recipient 101, such as if customer 102 has a criminal history or is a known criminal associate of recipient 101, for example. Customer 101 may then create and upload first video message 108 using RCD 106 for eventual viewing by recipient 102.

RCD 106 then transmits first video 108 to cloud server 103. In some embodiments, customer 101 goes to a video “mail box,” similar to an email inbox, and selects an onscreen option to send a recorded video message. Customer 101 then chooses a recipient 102. Customer 101 chooses either to pay to send the video or request recipient 102 to pay. Customer 101 then records first video 108 and saves first video 108 on messaging application 107 of the customer's RCD 106. REC 106 then transmits first video 108 to cloud server 103 utilizing RCD communication link 172. A record of first video 108 is queued in cloud server 103. Cloud processor 174 detects the new first video 108, archiving a copy of first video 108 to cloud memory 173, in some embodiments.

Screening is then performed on cloud processor 174. Screening is a multi-step process comprising computer-executed processes and processes manually executed by natural persons. Computer-executed processes, in some embodiments, comprise uploading first video 108 from RCD 106 to cloud server 103, wherein (processor) filters first video 108 based upon accepted configuration settings matched to a stored bank of indicia. Customer 101 is identified by face and voice recognition indicia. Additional persons are screened by comparing facial recognition indicia against a database of known persons, (mugshots, etc.). Groups of people and children are detected, using screening indicia. Nudity is detected. Language suggesting illegal, sexual, or conspirator content themes is detected. Overall visual context is detected, such as the presence of scantily clad persons, nudity, minor children, presence of weapons, and the like. (Processor) then creates a summary file and saves to (memory). A still-shot summary montage is created using individual frames from first video 108.

Filtering of first video 108 against an indicium 109 is performed on cloud server 103. In some embodiments, filtering is accomplished by filtering utility 120 resident on cloud processor 174. Processes describing initial computer-executed steps for screening and filtering of first message 108 are described herein above, in relation to FIG. 5.

After initial screening and filtering, facility server 104 downloads first video 108 from cloud server 103. This is accomplished by an interface between cloud communication link 175 and facility communication link 178.

A correctional officer 126 reviews first video 108, in some embodiments. As discussed herein above, cloud processor 174 generates a human-readable summary of first video 108 prior to transmission to facility server. Correctional officer 126 initially reviews the human readable summary, noting whether filtering utility 120 has identified any restricted or otherwise possibly objectionable content present on first video 108. Correctional officer 126 notes the location on the human-readable summary, noted by a time counter log, wherein a restricted or objectionable content item is located, and may queue first video 108 for direct viewing of the screened or filtered content. It should be noted that correctional officer 126 may be a correctional officer, an administrator, or other staff personnel tasked with managing recorded video communications between detainees and outside persons.

Correctional officer 126 determines whether first video 108 “passes” by meeting established criteria for recorded video communication between customer 101 and recipient 102. In some alternative embodiments, an alert is sent to a video monitor viewed by a staff video worker, who may or may not be a correctional officer. The staff video worker briefly checks a video data log maintained on facility server 104 to confirm proper identity of the intended recipient 102. In some embodiments, the staff video worker manually performs a checklist to determine or verify: a) whether the video file comprising first video 108 correctly formatted; b) whether recipient 102 has an account; c) if no, then the staff video worker sends a registration email; d) whether there is a promotion available, such as a discounted payment, then apply it; e) whether the correctional officer has approved communication between customer 101 and recipient 102; f) whether recipient 102 has consented to communicate with customer 101; g) whether customer 011 paying for the service; h) whether recipient 102 paying for the service; i) processes payment; j) confirms review of the human-readable summary by correctional officer 126; k) creates a video-index picture and/or a short random preview of first video 108 lasting several seconds; l) creates a thumbnail still-picture of first video 108; m) determines whether additional filtering is necessary, such as whether first video 108 should be manually filtered by a natural person manually; and n) log information required by the administrator of system 100 onto facility server 104.

Filtering is also done manually by a natural person or persons. Such person may be an administrative employee of institutional facility 111, including correctional officer 126. Selection for manual filtering, in some embodiments, can be configured to “random,” always,” “never,” or “statistically.” For example, if there are 100 first videos 108, a certain percentage of the videos would be reviewed by a natural person reviewer. Manual filtering comprises visually inspecting a computer-generated summary of first video 108, such as a montage. Each still image in the montage includes a time marker, wherein the reviewer may cue video message 108 to the time marker and observe a time segment of first video 108 proximate to the time marker of the selected still image of the visual summary. Additionally, a reviewer may elect to directly view an extended segment, or the entire first video 108, on an accelerated “fast forward” viewing speed. In some embodiments, the administrative employee provides a recommendation whether to have a correctional officer or senior administrator view first video 108.

In addition to manual viewing and filtering undertaken by correctional officer 126, or administrative staff member, first video 108 may additionally be viewed and filtered at a higher level by a correctional officer or senior administrator of institutional facility 111. This higher-level filtering, like the initial real-person filtering, can be assigned to a first video 108 as “random,” “always,” “never,” or “statistical.” Review may also be performed upon the recommendation of a lower-level reviewer, such as the administrative employee reviewer, or by (processor) in response to matching indicium 109 with content of first video 108. The senior reviewer has the discretion to either allow or block viewing of first video 108 by recipient 102.

If first video 108 is not rated “pass” by correctional officer 126, system 100 may archive or discard first video 108. For example, in some embodiments, a first video 108 not rated “pass” is uploaded by facility processor 177 to cloud memory 173 for archival storage. In some embodiments, a first video 108 not rated “pass” is stored on facility memory 176 for archiving, or for additional review.

If first video 108 is rated “pass” by correctional officer 126, system 100 alerts recipient 102 that first video 108 has been received and approved for viewing. A recipient alert 140 is delivered to recipient 102. Recipient alert 140 may be accomplished in a variety of ways. In some embodiments, for example, a video processing monitor located in plain view by a population of detainees broadcasts a message that first video 108 is available for viewing by recipient 101. Other means of notification are possible.

Recipient 102 determines whether to view first video 108. If recipient 102 chooses not to view first video 108, recipient 102 may indicate this rejection by imputing this choice into a facility remote computing device 130, such as a keypad, touchscreen GUI, or similar device electronically coupled to facility processor 177. Alternatively, recipient may simple ignore the alert message or otherwise fail to view first video 108 within a limited time period determined by the administrator of system 100. Facility processor then archives first video 108 on facility memory 176, uploads first video 108 to cloud server 103 for archival storage on cloud memory 173, in some embodiments. In some embodiments, facility processor 177 simply deletes first video 108 from system 100.

If recipient 102 elects to view first video 108, recipient 102 may view first video at a viewing terminal. The viewing terminal may be facility remote computing device 130, a viewing kiosk 142, or the like. Facility remote computing device and viewing kiosk 142 are computing devices comprising a monitor screen for viewing and a communication link with facility server 104. Facility remote computing device 130 also comprises a microprocessor. Recipient 102 logs into the viewing terminal. In some embodiments, the recipient's identity is confirmed by a utility resident on the microprocessor of facility remote computing device 130 comprising a software algorithm for recognition of a biometric parameter of recipient 102, such as facial, voice, or fingerprint recognition, or recognition of another biometric identification parameter unique to recipient 102. Recipient 102 then views first video 108.

Recipient 102 then decides whether he wishes to reply to customer 101. If “no,” processes of system 100 are complete.

If “yes,” then recipient 102 creates second video 118 on facility server 104. In some embodiments, recipient 102 records second video 118 at the viewing kiosk or workstation whereon recipient 102 views first video 108. In some embodiments, a second video 118 is recorded using a digital video recording means available at institutional facility 111 separate from system 100, wherein the recorded second video 118 is uploaded to facility server 104.

Facility server 104 then transmits second video 118 to cloud server 103. In some embodiments, facility communication link 178 interfaces with cloud communication link 175 to effect uploading of second video 118 to cloud server 103.

After uploading, filtering utility 120 resident on cloud processor 174 filters second video 118 against indicium 109, in a manner similar to which computer-executed processes specific to filtering utility 120 screens and filters first video 108. In some embodiments, filtering utility 120 screens and filters second video 118 against a plurality of indicia. The operation of filtering utility 120 is discussed in detail in connection with FIG. 5. If second video 118 does not pass the screening functions of screening utility 120, second video 118 is either deleted from system 100 or, alternatively, archived on cloud memory 173.

If second video 118 successfully passes screening against indicium 109 by screening utility 120, cloud server 103 queues second video 118 for download to RCD 106 and generates a customer alert 143 to notify customer 101 that second video 118 is available for viewing. If customer 101 chooses to view second video 118, customer 101 downloads second video 118 from cloud server 103 onto RCD 103 using messaging application 107. Alternatively, if customer 101 chooses not to view second video 118, second video 118 is archived on cloud memory 173 or deleted from system 100.

Customer 101 then downloads and views second video 118 on RCD 106. Customer may then choose to record and send a new first video 118, or to log off from system 100, completing the process.

Receipt of a payment 150 is accomplished by a payment processing means. In some embodiments, a third-party payment gateway provider is utilized to receive and process payments 150 and payment information. Cost is determined based upon the length of first video 108 or second video 118, in some embodiments. Customer 101 may allow recipient 102 to reply with second video 118 without paying; wherein customer 101 pays. Customer 101 may approve or “black list” (block) an individual recipient 102 from sending a video 118 to customer 101.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

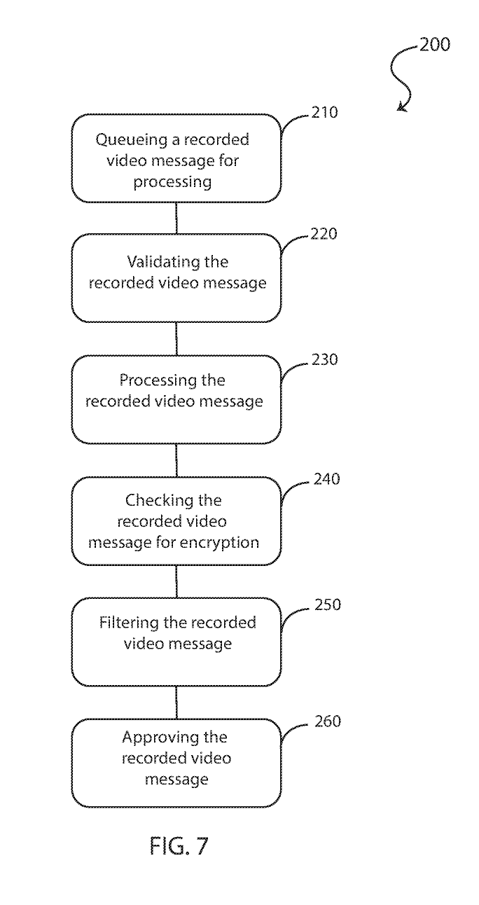

FIG. 7 is a block diagram of a method of monitored video messaging. FIG. 7 shows a block diagram of a method of providing a monitored video message. As shown by FIG. 7, method 200 comprises a queuing step 210, a validating step 220, a processing step 230, a checking step 240, a filtering step 250, and an approving step 260.

Queuing step 210 comprises quieting a recorded video message for processing. Queuing step 210 is performed, in some embodiments, on a cloud-based server following receipt of a recorded video from a remote computing device over a communications network, such as the Internet or a cellular telephone network, for example. A single cloud-based server may receive recorded video messages from a plurality of remote computing devices for processing.

Validating step 220 comprises validating the queued recorded video message. Validating step 220, in some embodiments, is performed by a screening utility resident on a cloud-server based microprocessor. Sub-steps comprising validating step, in some embodiments, include any number or combination of computer-executed steps such as confirming whether the sending customer is authorized to send recorded video messages to an intended recipient on the system and confirming the identity of the sending party using a verifiable biometric measurement or a plurality of biometric measurements unique to the sending party.

Processing step 230 comprises processing the recorded video message by generating a recorded data log of background demographic information specific to the customer sender and the intended recipient. Processing step 230 additionally comprises, in some embodiments, noting and loging the length of the recorded video and preparing a template for a computer-generated human-readable linear “timeline” summary of the recorded video.

Checking step 240 comprises checking the recorded video message for encryption. Checking step 240 is performed by an encryption utility resident on the cloud server microprocessor. Wherein the recorded video message is found to be an encrypted video message, the encryption utility verifies the recorded video message is properly encrypted and not corrupted, in some embodiments.

Filtering step 250 comprises processing the recorded video message. Processing step 230 is performed by a filtering utility resident on the cloud-based server microprocessor, in some embodiments. The filtering utility review the recorded video for illegal or possibly objectionable content by comparing video images and audio content against a bank of stored indicia. For example, the filtering utility may compare the recorded video against stored indicia comprising a facial recognition indicium, a voice recognition indicium, an maturity recognition indicium, a nudity recognition indicium, and a speech-content recognition indicium.

Approving step 260 comprises approving the recorded video message. Approving step 260 comprises a computer executed process and a natural person executed process, in some embodiments. The computer executed process may comprise filtering out restricted or objectionable content by the filtering utility, recording the types and number of restricted or objectionable content events on a human-readable summary, and the like. The computer executed process may be performed by the filtering utility resident on the cloud-based server microprocessor, a facility-server microprocessor, or a combination of microprocessors located on respective servers in two or greater geographic locations. The natural person executed process is performed, in some embodiments, at an institutional facility wherein detainees, including the intended recipient of the recorded video message, are housed by an administrative staff member, a video-review staff member, a correctional officer, or an alternative natural person responsible for final approval of the recorded video message for viewing by the intended recipient.

It is understood that method 200 comprises queuing, validating, processing, checking, filtering, and approving steps discussed herein. Method 200 may include any number of additional steps, in some embodiments.

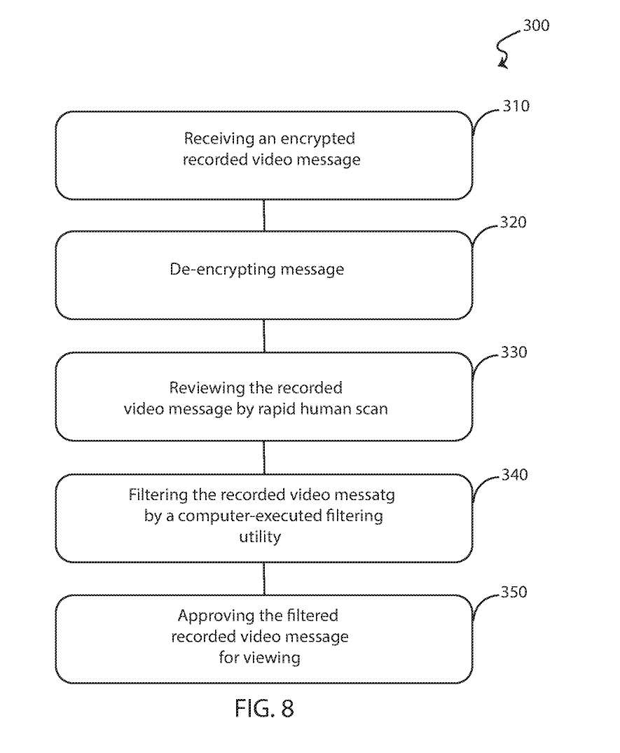

FIG. 8 is a block diagram of an additional method of monitored video messaging.

FIG. 8 shows a method 300 comprising a receiving step 310, a de-encrypting step 320, a reviewing step 330, an filtering step 340, and an approving step 350.

Receiving step 310 comprises receiving an encrypted recorded video message. In some embodiments, the encrypted recorded video message is received from a remote computing device by a cloud-based server. In some embodiments, the sender of the encrypted recorded video message is an attorney representing the intended recipient.

De-encrypting step 320 comprises de-encrypting the received encrypted recorded video message. A utility resident on a microprocessor of the cloud-based server de-encrypts the recorded encrypted video message and prepares the de-encrypted message for viewing by a natural person reviewier, in some embodiments.

Reviewing step 330 comprises reviewing the de-encrypted recorded video message by rapid human scanning. The de-encrypted recorded video message is viewed directly by a natural human reviewer. The reviewer may be an administrative staff member, a correctional officer, a video review staff member, or like person employed by an institutional facility housing the intended recipient of the recorded video message. Reviewing step 330 may comprise performing a quick “fast forward” visual scan of the recorded video message, a review of a computer-generated human-readable summary created by a utility resident on the cloud server microprocessor, wherein restricted or possibly objectionable content has been marked on a linear timeline of the recorded video message, or like summary review process.

Filtering step 340 comprises filtering the recorded video message by a computer-executed filtering utility. In some embodiments, filtering step 340 is executed by a filtering utility resident on a cloud-based server microprocessor. Filtering step 340 identifies and blocks restricted and possibly objectionable video and audio content on the recorded video message. In some embodiments, filtering step 340 comprises comparing the recorded video message against stored indicia, such as facial recognition indicia, voice recognition indicia, age recognition indicia, nudity recognition indicia, or speech content recognition indicia. This list is by example and not meant to be limiting; additional examples of biometric-based and other indicia are possible and within the intended scope of the invention.

Approving step 250 comprises approving the filtered message for viewing. In some embodiments, approving step 250 is performed by a natural person, such as an administrative staff member, a senior administrator or manager, a correctional officer, or an administrator of a system and process for monitored video communication, for example. Approving step may comprise performing a final verification of identities of the sending customer and the intended recipient, confirming permissions provided by the institutional facility wherein the intended recipient resides for viewing of recorded video messages by the intended recipient or from the customer, and final review of a computer-generated human readable summary, for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A system for monitored video messaging comprising:
a cloud server;
a remote computing device communicatively coupled to the cloud server comprising a messaging application, wherein a customer uploads a video message formatted by the messaging application to the cloud server from the remote computing device;
a facility server communicatively coupled to the cloud server and comprising a filtering application, wherein the filtering application screens the video message against an indicium to create a filtered video message; and
a viewing station, wherein a recipient views the filtered video message at the viewing station.

2. The system of claim 1, wherein the recipient is an inmate of a correctional facility.

3. The system of claim 1, wherein the facility server is remotely located separate from a correctional facility.

4. The system of claim 1, wherein the indicium is a facial-recognition indicium.

5. The system of claim 1, wherein the indicium is a voice-recognition indicium.

6. The system of claim 1, wherein the indicium is a nudity-recognition indicium.

7. The system of claim 1, wherein the indicium is a maturity-recognition indicium.

8. The system of claim 1, wherein the indicium is a weapon-recognition indicium.

9. The system of claim 1, wherein the cloud server comprises an encryption utility.

10. The system of claim 1, wherein
the customer is an attorney;
the messaging application comprises an encryption utility;
the encryption utility encrypts the video message; and
the remote computing device uploads the encrypted video message to the cloud server.

11. A system for monitored video messaging comprising:
a facility server comprising
a filtering utility;
a databank populated with indicia; and
a video message; wherein the filtering utility compares the video message with the indicia to create a filtered video message; and
a viewing kiosk communicatively coupled to the facility server, comprising
a recipient verification utility that verifies a recipient identity;
a payment utility that verifies a payment; and
a monitor,
wherein the filtered video message is viewed at the viewing station by the recipient following verification of the recipient identity and the payment.

12. The system of claim 11, wherein the payment is provided by the recipient at the kiosk.

13. The system of claim 11, wherein the payment is provided by a third party.

14. The system of claim 11, wherein the facility server is communicatively coupled to a cloud server, and wherein the video message is received by the facility server from the cloud server.

15. The system of claim 11, wherein the facility server is communicatively coupled to a remote computing device, wherein the video message is received by the facility server from the remote computing device.

16. A method for monitored video messaging comprising:
receiving a video message from a customer;
validating the video message;
processing the video message by comparing the video message to an indicium;
approving the video message for viewing by a recipient; and
viewing the video message by the recipient.

17. The method of claim 16, wherein the processing step comprises:
comparing the video message to an indicium; and
selecting a filtered video message comprising the indicium.

18. The method of claim 16, further comprising tendering a payment.

19. The method of claim 16, further comprising reviewing the video for final approval to be viewed by the recipient.

20. The method of claim 16, further comprising publishing an alert, wherein the alert notifies the recipient that the video is available for viewing.
